(19) United States
(12) Patent Application Publication
(10) Pub. No.: US 2009/0051418 A1
(43) Pub. Date: Feb. 26, 2009

(54) DISTRIBUTED VOLTAGE REGULATOR

(76) Inventors: DIETMAR GOGL, Essex Junction, VT (US); Ernst Stahl, Essex Junction, VT (US)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/842,254

(22) Filed: Aug. 21, 2007

(51) Int. Cl. G05F 1/10

(52) U.S. Cl. 327/540

(57) ABSTRACT

An integrated circuit device and a method for providing distributed voltage regulation. The device includes a plurality of memory cell arrays and access circuitry dependent on one or more regulated voltages generated on the device and a plurality of pulsed digital distributed output units configured to generate the one or more regulated voltages. The device also includes a voltage regulator control logic configured to generate one or more control signals to control the distributed output units based, at least in part, on a comparison between one or more reference voltages and the one or more regulated voltages.

### BACKGROUND OF THE INVENTION

In integrated circuits, internal voltages are often supplied by voltage regulators. Voltage regulators typically create different internal voltages from the supply voltage applied externally to the chip. The internally created voltages are typically independent from variations of the supply voltage externally applied to the chip. In some cases, analog voltage regulators are used in order to create internal chip voltages. Based on a reference voltage, an output voltage of the analog voltage regulator is adjusted continuously. The voltage regulator continuously adjusts its output current dependent on variable load conditions in order to provide the specified output voltage.

Due to certain known limitations of analog voltage regulators, digital voltage regulators may be used. Digital voltage regulators are more efficient at supplying a target value for the output voltage, for example, by providing high output currents using low regulator bias currents.

### SUMMARY OF THE INVENTION

One embodiment of the invention provides an integrated circuit device and a method for providing distributed voltage regulation. The device includes a plurality of memory cell arrays and access circuitry dependent on one or more regulated voltages generated on the device and a plurality of pulsed digital distributed output units configured to generate the one or more regulated voltages. The device also includes a voltage regulator control logic configured to generate one or more control signals to control the distributed output units based, at least in part, on a comparison between one or more reference voltages and the one or more regulated voltages.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a system view of a memory device, according to one embodiment of the invention.

FIG. 2 is a system view of DRAM with distributed output voltage units, control circuitry, and a negative feedback loop, according to one embodiment of the invention.

FIG. 3A is a block diagram of the distributed digital voltage regulator with negative feedback loop, according to one embodiment of the invention.

FIG. 3B is a block diagram of the pull-up output unit, according to one embodiment of the invention.

FIG. 3C is a block diagram demonstrating the principle of multiple distributed outputs units, according to one embodiment of the invention.

FIG. 4 is a distributed voltage regulator represented by a flowchart, according to one embodiment of the invention.

FIG. 5 is a digital voltage regulator control logic timing diagram, according to one embodiment of the invention.

FIG. 6A is a block diagram of a clocked push-pull voltage regulator, according to one embodiment of the invention.

FIG. 6B is one implementation of a distributed output unit, according to one embodiment of the invention.

FIG. 6C is one implementation of multiple distributed output units, according to one embodiment of the invention.

FIG. 7 is a clocked push-pull voltage regulator with distributed output devices represented by a flowchart, according to one embodiment of the invention.

FIGS. 8A and 8B are block diagrams depicting clocked push-pull voltage regulator timing diagrams according to embodiments of the invention.

FIG. 9A is a block diagram of a clocked push-pull voltage regulator with cross current inhibiting logic, according to one embodiment of the invention.

FIG. 9B is one implementation of cross current inhibit logic, according to one embodiment of the invention.

FIG. 9C is an output unit with cross current inhibiting logic, according to one embodiment of the invention.

FIG. 9D is one implementation of cross current inhibit logic shared between multiple distributed output units, according to one embodiment of the invention.

### DETAILED DESCRIPTION OF THE PREFERRED EMBODIMENT

Embodiments of the invention generally provide an integrated circuit device and a method for operating the integrated circuit device. The integrated circuit device includes a plurality of memory cell arrays and access circuitry dependent on one or more regulated voltages generated on the device. The integrated circuit device also includes a plurality of pulsed digital distributed output units configured to generate the one or more regulated voltages and voltage regulator control logic. The voltage regulator control logic is configured to generate one or more control signals to control the distributed output units based, at least in part, on a comparison between one or more reference voltages and the one or more regulated voltages.

Embodiments of the invention may generally be used with any type of memory. In one embodiment, the memory may be a circuit included on a device with other types of circuits. For example, the memory may be integrated into a processor device, memory controller device, or other type of integrated circuit device. Devices into which the memory is integrated may include system-on-a-chip (SOC) devices. In another embodiment, the memory may be provided as a memory device which is used with a separate memory controller device or processor device.

In both situations, where the memory is integrated into a device with other circuits and where the memory is provided as a separate device, the memory may be used as part of a larger computer system. The computer system may include a motherboard, central processor, memory controller, the memory, a hard drive, graphics processor, peripherals, and any other devices which may be found in a computer system. The computer system may be part of a personal computer, a server computer, or a smaller system such as an embedded system, personal digital assistant (PDA), or mobile phone.

In some cases, a device including the memory may be packaged together with other devices. Such packages may include any other types of devices, including other devices with the same type of memory, other devices with different types of memory, and/or other devices including processors and/or memory controllers. Also, in some cases, the memory may be included in a device mounted on a memory module. The memory module may include other devices including memories, a buffer chip device, and/or a controller chip device. The memory module may also be included in a larger system such as the systems described above.

In some cases, embodiments of the invention may be used with multiple types of memory or with a memory which is included on a device with multiple other types of memory. The memory types may include volatile memory and non-volatile memory. Volatile memories may include static random access memory (SRAM), pseudo-static random access memory (PSRAM), and dynamic random access memory (DRAM). DRAM types may include single data rate (SDR) DRAM, double data rate (DDR) DRAM, low power (LP) DDR DRAM, and any other types of DRAM. Nonvolatile memory types may include magnetic RAM (MRAM), flash memory, resistive RAM (RRAM), ferroelectric RAM (FeRAM), phase-change RAM (PRAM), electrically erasable programmable read-only memory (EEPROM), laser programmable fuses, electrically programmable fuses (e-fuses), and any other types of nonvolatile memory.

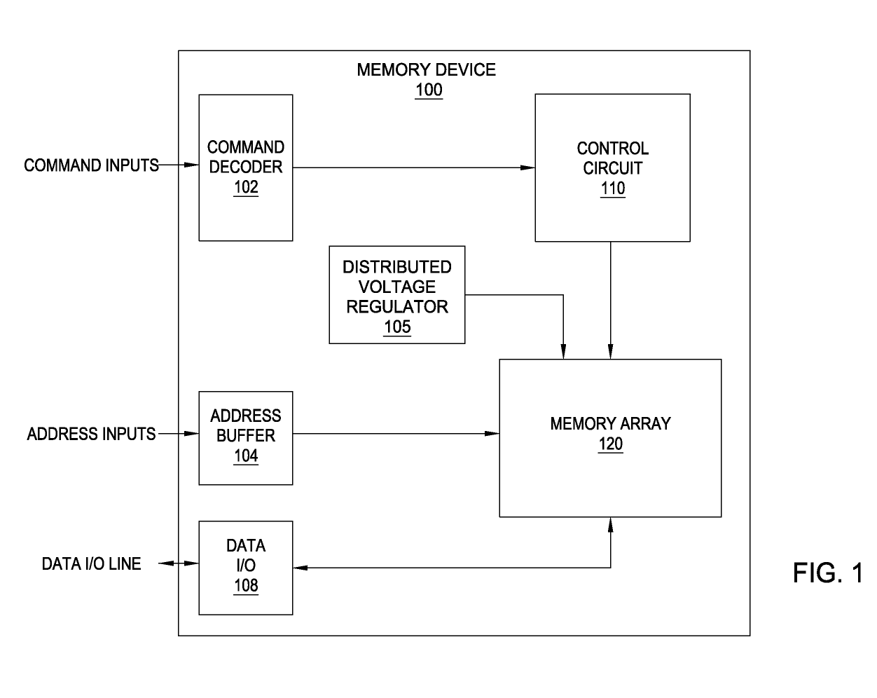

FIG. 1 is a block diagram a memory device 100 according to one embodiment of the invention. The memory device 100 may include address inputs and command inputs. The address inputs may be received at an address buffer 104 and the command inputs may be receive at a command decoder 102. The command decoder 102 may decode commands and provide decoded command information to a control circuit 110. The control circuit 110 may use the decoded command information in addition to the address inputs to access information in a memory array 120. In some cases, the device 100 may include multiple memory arrays 120 which may be accessed. Data may be input and output from the memory arrays 120 via data I/O circuitry 108.

Embodiments of the invention provide digital voltage regulation which may be used to provide supply voltages to the memory device 100 depicted above. Digital voltage regulation offers one way to implement distributed internal voltage regulation. One embodiment provides voltage regulator output voltage which is evenly supplied over large areas of the memory device 100. In one embodiment, the regulator output voltage is distributed evenly to the memory device 100 using digitally controlled output devices placed on the memory device 100. Control of these output devices over long distances across the memory device 100 is improved in one embodiment by using control signals which are digital.

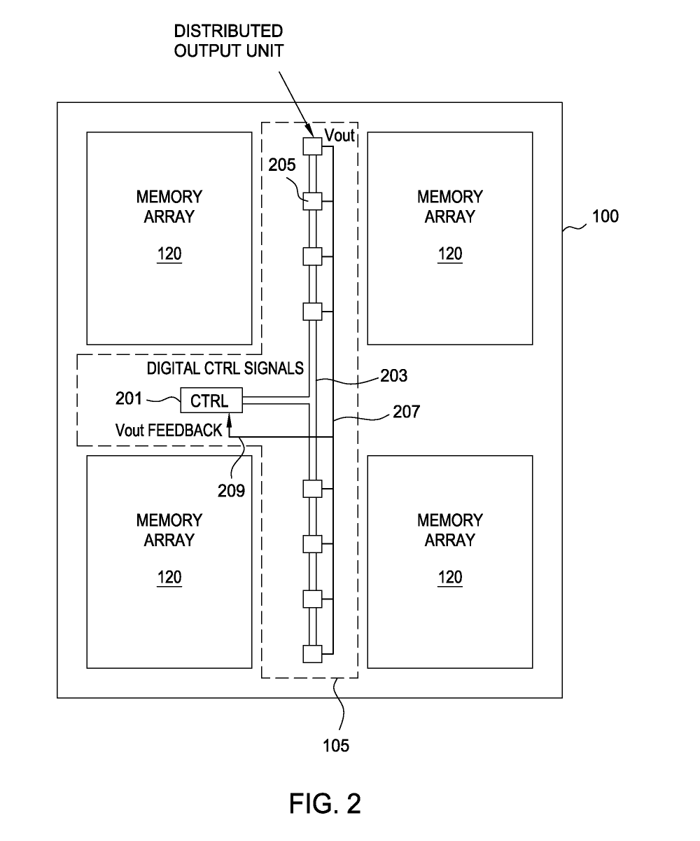

FIG. 2 is diagram depicting distributed digital voltage regulator of the memory device 100 according to one embodiment of the invention. The distributed regulator includes distributed output devices 205 and a controller 201. The distributed output devices 205 are used to provide a regulated output voltage 207 to circuitry of the memory device 100. As described below, the controller 201 receives the output voltage 207 in the form of negative feedback 209 and determines if the output voltage 207 is being maintained at a desired level. If the output voltage 207 is not being maintained at a desired level, one or more digital pulsed signals (e.g., binary signals) are provided to the distributed output devices 205 thereby causing the output voltage 207 to be restored to a desired level.

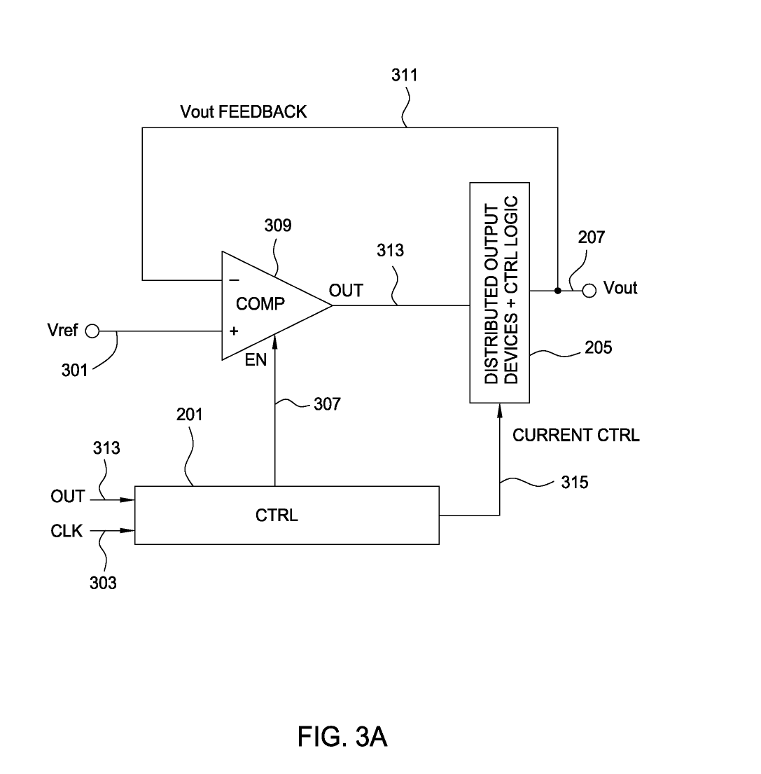

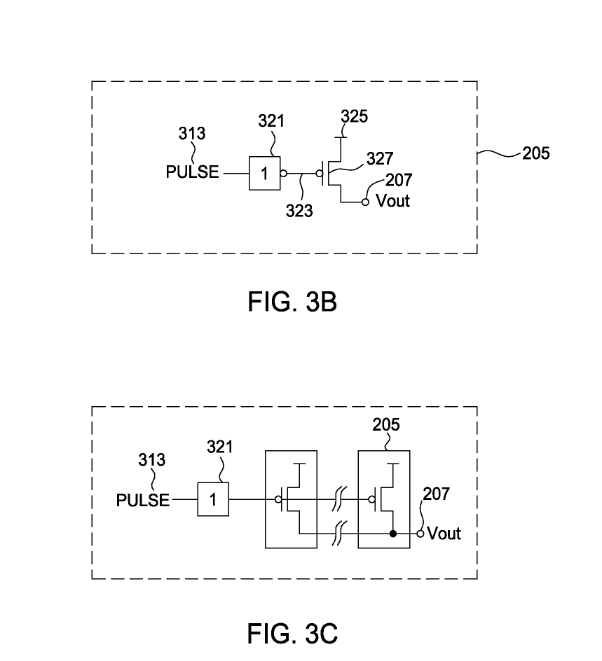

FIG. 3A is a block diagram depicting further details of the distributed voltage regulator according to one embodiment of the present invention. As depicted, the voltage regulator may include a comparator 309 which may be used to compare the output voltage 207 to a reference voltage 301 via a feedback connection 311 to determine if the output voltage 207 is being maintained at a desired level. If the output voltage 207 is not being maintained at a desired level, a digital output pulse 313 may be provided to the distributed output devices 205 thereby causing the output voltage 207 to be restored to a desired level.

During voltage regulation, the control logic 201 may assert an enable signal 307 which may be used to enable and disable the comparator 309. For example, when the comparator 309 is disabled, no voltage regulation of the output voltage 207 may be performed, thereby conserving power in the memory device 100. When the comparator 309 is enabled, the output voltage may be regulated as described herein. In one embodiment, to reduce power consumption, the comparator 309 may be periodically disables using a clock signal 303 provided to the control logic 201. For example, when the clock signal 303 is low, the comparator 309 and the control logic 201 may both be disabled. When the clock signal is high, the comparator 309 and the control logic 201 may both be enabled.

Furthermore, in one embodiment, to further decrease power consumption, the control logic 201 may be configured to determine whether the comparator 309 is being used to perform voltage regulation. For example, when the control logic 201 is activated (e.g., by a rising edge of clock signal 303), the control logic 201 may be configured to remain activated for a defined period of time (e.g., 10 microseconds). During the defined period of time, the control logic 201 may determine whether regulation of the output voltage 207 is required, for example, by examining the digital output pulse 313. If the comparator 309 asserts the digital output pulse 313 to regulate the output voltage 207, then the control logic 201 and the comparator 309 may remain enabled. If, however, the digital output pulse 313 is not asserted in the defined time period, then the control logic 201 and the comparator 309 may be disabled until the next clock signal 303 is received.

In one embodiment, the control logic 201 may also provide a current control signal 315. The current control signal 315 allows for the manipulation of the driver strength of the distributed output devices 205 dependent on operating conditions of the memory device. An example of different operating conditions could include chip power-on conditions as compared to normal operating conditions. An example of the manipulation of the driver strength could include activating wider pull-up or pull-down transistors in the distributed output devices 205 for higher output currents during power-on conditions and activating narrower transistors during normal operating conditions.

FIG. 3B shows one implementation of a pull-up output unit 205. The digital output pulse 313 is fed into an inverter 321. The inverted pulse 323 is utilized as the gate control signal of a PMOS transistor 327. When activated, the PMOS transistor allows a supply voltage 325 to pass through to the output node 207. As described above, by activating the distributed output unit 205 using the pulse 313, the output voltage 207 may be maintained at a desired level. In some cases, multiple distributed output units 205 may also be operated by a single digital output pulse 313 as depicted in FIG. 3C.

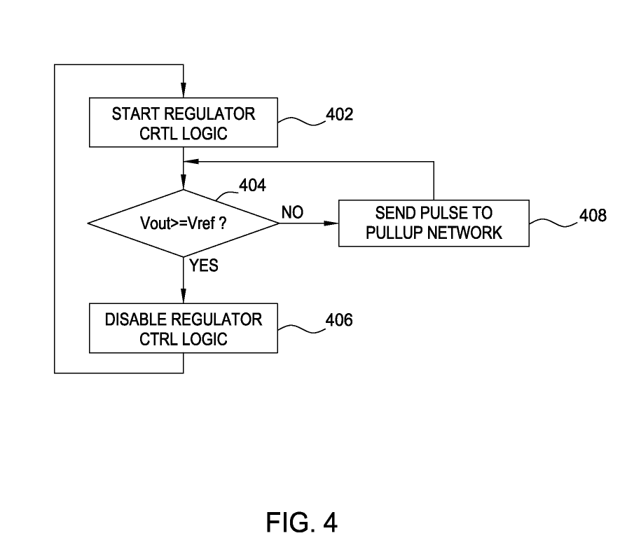

FIG. 4 is a flowchart depicting distributed voltage regulation according to one embodiment of the invention. At step 402, when a clock signal 303 is received, voltage regulator control logic 201 may be started. Then, at step 404, a comparison is made between the output voltage 207 and the reference voltage 301. Should the output voltage 207 be less than the reference voltage 301, the comparator 309 will send a digital pulse 313 to the pull-up network of digitally controlled output units 205 at step 408. If the output voltage 207 is greater than the reference voltage 301, the voltage regulator control logic 201 will be disabled at step 406, which disables the comparator 309 and other regulator circuitry.

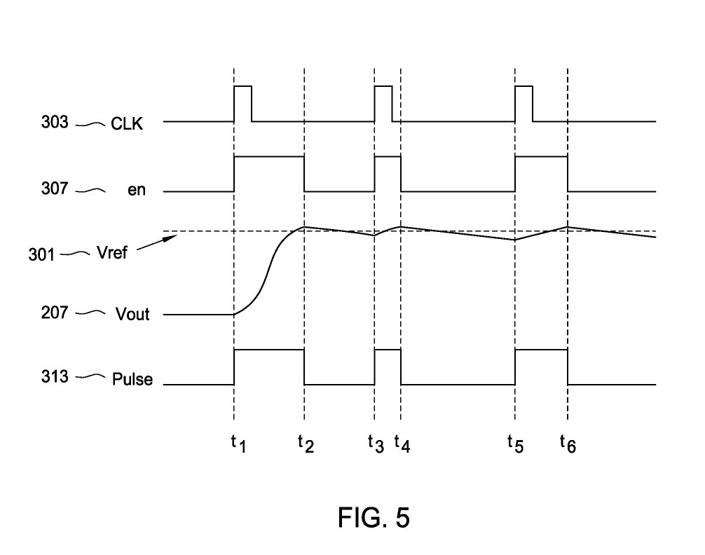

FIG. 5 is a timing diagram depicting distributed voltage regulation according to one embodiment of the invention. As depicted, the periodic clock signal 303 may be used to activate the regulator control logic 201. The control logic 201 may in turn enable the comparator 309 via the comparator enable signal 307. When the comparator 309 is enabled and determines that the output voltage 207 is less than the reference voltage 301, the comparator 309 may assert the pulse signal 313 which is received by the output modules 205 thereby causing the output modules 205 to be activated and drive the output voltage 207 above the reference voltage 301.

Times t1-t2 in FIG. 5 depict a power-on phase according to one embodiment. As depicted, the regulator control circuitry 201 is activated by receiving a rising edge of clock signal 303 at time t1. In response, the regulator control circuitry 201 asserts the enable signal 307 which activates the comparator 309. The activated comparator 309 determines that the output voltage 207 is below the reference voltage 301 and asserts pulse signal 313 which is provided to the output modules 205. When the output modules 205 receive the pulse signal 313, the modules 205 charge up the net output voltage 207 from the ground voltage (0V) to slightly above the reference voltage 301. At time t2 the regulator circuitry (including comparator 309, control logic 201, and output modules 205) disables itself upon detecting via comparator 309 that the output voltage 207 has risen above the reference voltage 301.

Between time t2-t3, an output leakage current discharges the capacitive output load of the regulator system to ground voltage. Then, at time t3, a rising edge of the clock signal 303 activates the control logic 201 again. The control logic 201 then enables the comparator 309 by asserting the enable signal 307. Upon being enabled, the comparator 309 detects that the output voltage 207 has is below the reference voltage 301 and asserts the pulse signal 313. When the pulse signal 313 is asserted, the output modules 205 are activated, thereby raising the output voltage 207 back above the reference voltage 301. Thus, at time t4, the output voltage 207 is corrected again and the regulator circuitry automatically shuts itself down again (as described with respect to time t2 above). Then, from times t4-t5, the output voltage gets slightly discharged again due to a load current to ground voltage. Then, at time t5, the clock signal 303 activates the regulator circuitry again, thereby activating control logic 201. The comparator 309 is again activated by the enable signal 307 and the output pulse 313 gets asserted again from time t5-t6 until the output voltage 207 is corrected again. The regulator circuitry then shuts down again at time t6 as described above with respect to time t2.

As depicted in FIG. 5, in some cases the output voltage 207 may be regulated slightly above the reference voltage 301, thereby overshooting the reference voltage 301. The overshoot may be caused by the reaction time of comparator 309, control logic 201, and wire delays in the regulator circuitry. Furthermore, as depicted in FIG. 5, the regulator circuitry activation time adapts automatically depending on the output voltage level 207 to be corrected. Thus, as depicted in FIG. 5, the pulse intervals t1-t2, t3-t4, and t5-t6 may have different lengths depending on the output voltage level 207 to be corrected.

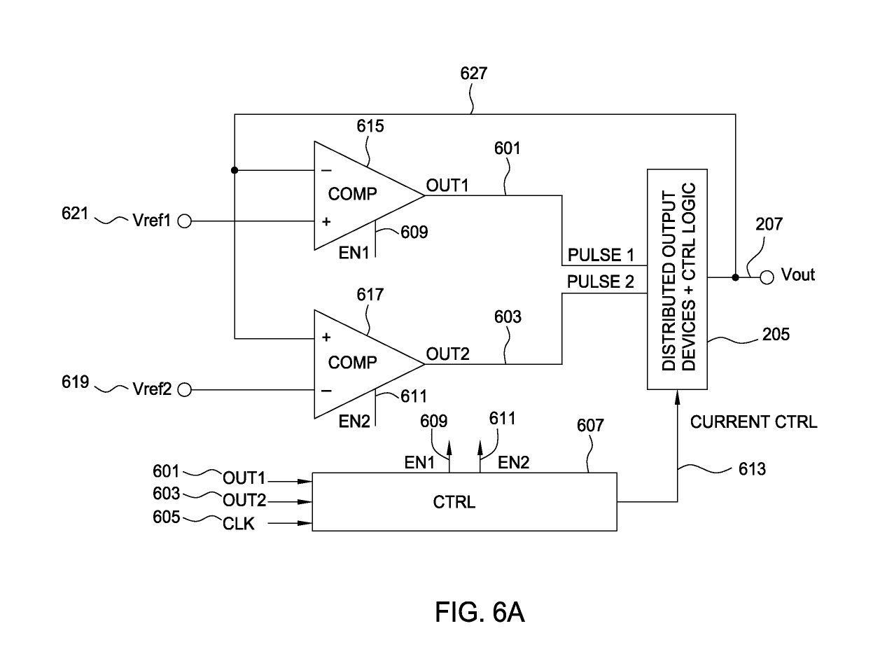

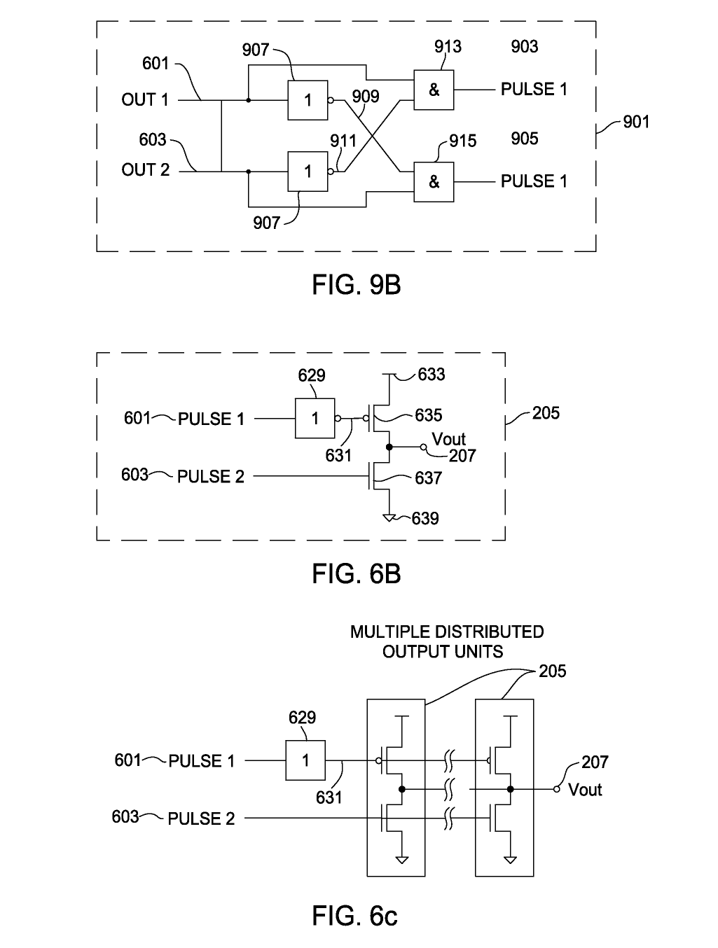

FIG. 6A shows another embodiment of a distributed voltage regulator, utilizing a clocked push-pull voltage regulator according to one embodiment of the invention. As depicted, the control logic 607 receives a clock signal 605 and two output signals 601 and 603. The output signals are the outputs of comparators 615 and 617. The control logic outputs two enable signals 609 and 611 that are sent to the comparators 615 and 617 and a current control signal 613. The current control signal 613 allows for the manipulation of the driver strength of the distributed output devices 205 dependent on operating conditions as described above. The first comparator 615 examines the feedback of the output voltage 627 with respect to a first reference voltage 621. Should the output voltage 627 be lower than the first reference voltage 621, the first comparator 615 outputs a digital output pulse 601 that is provided to the distributed output devices 205 and to the control logic 607, thereby maintaining the output voltage 207 above the first reference voltage 621. Simultaneously, a second comparator 617 examines the feedback of the output voltage 627 with respect to a second reference voltage 619. Should the output voltage 207 be higher than the second reference voltage 619, the second comparator 617 outputs a digital output pulse 603 that is dispersed to the distributed output devices 205 and to the control logic 607, thereby maintaining the output voltage 207 below the second reference voltage 619 and between the first and second reference voltages 619, 621, thus creating a hysteresis. In some cases, by maintaining the output voltage 207 between the first and second reference voltages 619, 621, periodic oscillation of the output voltage 207 due to voltage overshoots and undershoots will be avoided. Over- and undershoots of the output voltage occur because of the reaction time of the regulator system (e.g., propagation delays of the comparators 615, 617, control logic and signal delays on feedback wiring etc.) causing a delayed deactivation of the distributed output devices 205. The described hysteresis also helps to prevent unwanted cross-currents by avoiding of activation of the pull-up and pull-down functionality of the distributed output devices 205 at the same time.

FIG. 6B shows one implementation of a push-pull output unit 205 which may be used with the regulator circuitry of FIG. 6A according to one embodiment of the invention. The first digital output pulse 601 is fed into an inverter 629. The inverted pulse 631 is utilized as the gate control signal of a PMOS transistor 635. When activated, the PMOS transistor allows a supply voltage 633 to pass through to the output node 207. The second digital output pulse 603 is utilized as the gate control signal of an NMOS transistor 637. When activated, the NMOS transistor allows the output node 207 to be grounded 639. As described above, by using the first and second pulse 601, 603, the output voltage 207 may be maintained within a desired voltage range by pulling-up or pulling-down the output voltage 207 as desired. In one embodiment, multiple distributed push-pull output units 205 may be operated by a single set of digital output pulses 601 and 603 as depicted in FIG. 6C.

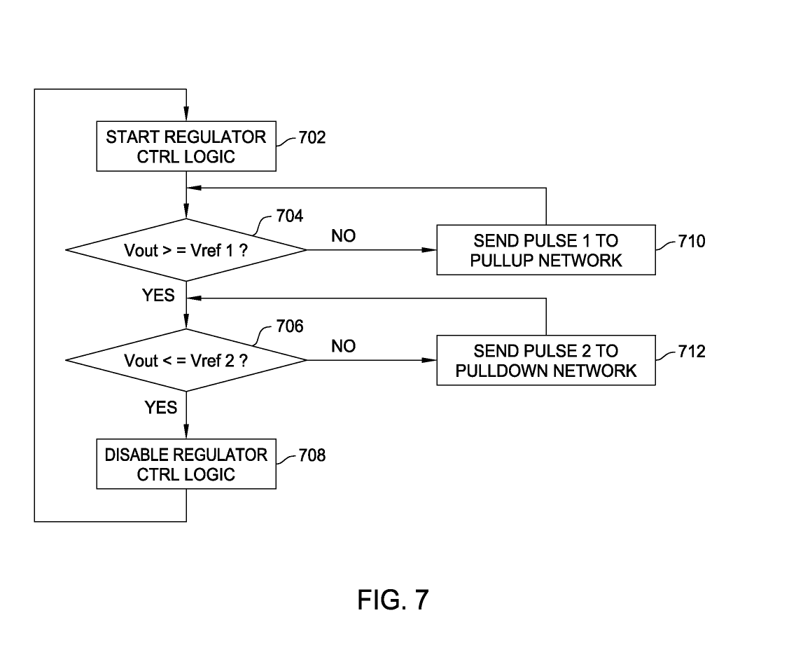

FIG. 7 is a flowchart depicting distributed voltage regulation utilizing a clocked push-pull voltage regulator according to one embodiment of the invention. At step 702 the voltage regulator control logic is started, and at step 704 a comparison is made between the output voltage 207 and the first reference voltage 621. Should the output voltage 207 be less than the first reference voltage 621 the first comparator 615 will send a digital pulse 601 to the pull-up network at step 710. At step 706, a comparison is made between the output voltage 207 and the second reference voltage 619. Should the output voltage 207 be greater than the second reference voltage 619, the second comparator 617 will send a digital pulse 603 to the pull-down network at step 712. If the output voltage 207 is less than the second reference voltage 619 and greater than the first reference voltage 621, then the voltage regulator control logic 201 will be disabled at step 708. This also disables the entire generator system (e.g., including comparators 615, 617 and output units 205), which is then placed in a state waiting for activation by a new rising edge of clock signal 605.

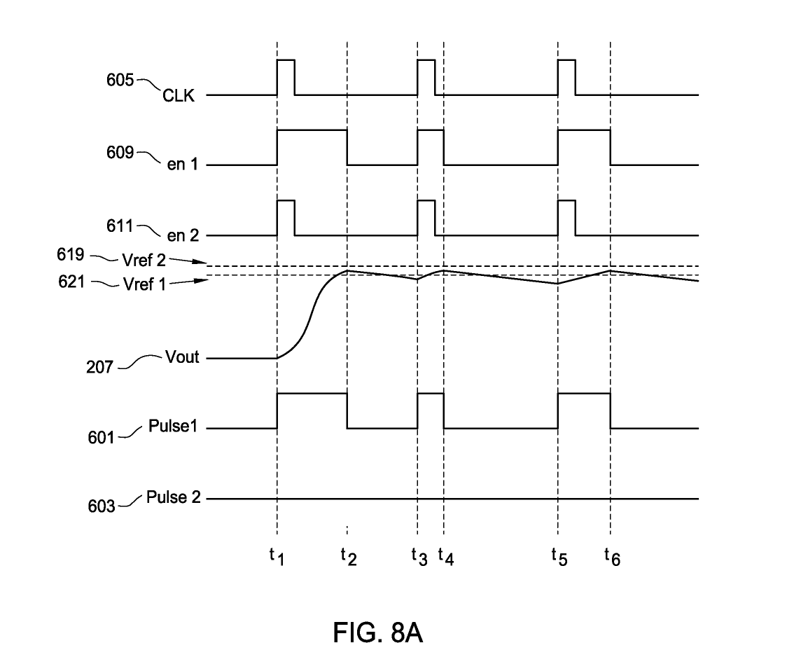

FIGS. 8A and 8B are timing diagrams depicting distributed voltage regulation utilizing clocked push-pull voltage regulation according to embodiments of the invention. FIG. 8A depicts voltage regulation in which leakage currents draw the output voltage 207 to a ground voltage (0V). As depicted, the clock signal 605 may be used to activate the regulator control logic 201. Upon being enabled, the regulator control logic 201 may enable the comparators 615, 617 via the enable signals 609, 611. As described above, the digital pulses 601, 603 may be used to activate the distributed output modules 205. The output voltage 207 may then be regulated at the distributed output modules 205 as described herein.

Times t1-t2 in FIG. 5 depict an example of a power-on phase where the regulation circuitry charges the net output voltage 207 from 0V to slightly above the first reference voltage 621. The control circuitry 201 is activated by a rising edge of the clock signal 605 at time t1. When the control circuitry 201 is activated, both the first and second comparators 615, 617 are activated by the first and second enable signals 609, 611. Upon being activated, the first comparator asserts a first pulse signal 601 from times t1-t2 in order to charge the output voltage 207 up to the first reference voltage 621. The second pulse 603 stays deactivated because the output voltage 207 remains below the second reference voltage 619. At time t2, when the first comparator 615 determines that the output voltage 207 is above the first reference voltage 621, the regulator circuitry (including comparator 309, control logic 201, and output modules 205) disables itself.

Between times t2-t3, an output leakage current discharges the capacitive output load of the voltage regulation system to ground. At time t3, the clock signal 605 activates the control logic 607 again. Both comparators 615, 617 are enabled and because the output voltage 207 is below the first reference voltage 621, the first comparator 615 asserts a first pulse signal 601 which activates the output modules 205 causing the output modules to pull up the output voltage 207. The second pulse signal 603 remains deactivated because the output voltage 207 is below the second reference voltage 619. At time t4, the output voltage 207 is corrected again and the regulator circuitry shuts itself down again as described with respect to time t2 above.

Between times t4-t5, the output voltage 207 gets slightly discharged again due to a load current to ground. The clock signal 605 activates the control logic 607 and other regulator circuitry again at time t5. Accordingly, at times t5-t6, the first pulse signal 601 is asserted until the output voltage 207 is corrected again. The regulator circuitry then shuts down at time t6 as described with respect to time t2 above. Also, as described above, the second pulse signal 603 stays deactivated again because the output voltage 207 remains below the second reference voltage 619.

As depicted in FIG. 8A, the output voltage 207 gets regulated slightly above the first reference voltage 621 (overshoot). This is caused by the reaction time of comparators 615, 617, control logic 607, and wire delays in the regulator circuitry. Also, as depicted, the regulator circuitry activation time adapts automatically depending on the output voltage level to be corrected. As a result, FIG. 8A also depicts that the pulse intervals t1-t2, t3-t4, and t5-t6 for the first pulse 601 have different lengths. Furthermore, the second pulse signal 603 is not activated in the example in FIG. 8A because the output voltage 207 remains below the second reference voltage 619. The first and second enable signals 609, 611 get activated periodically by the control logic 607 in response to clock signal 605. However, as depicted, the second enable signal 611 is lowered after the time allowed for the second comparator 617 to determine that no action is required. Further, the first enable signal 609 remains asserted and activates the regulator circuitry as long as needed in order to correct regulator output voltage 207. Therefore, the two reference voltages 619, 621 create a hysteresis window. When the output voltage 207 is between the first and second reference voltages 619, 621, the regulator circuitry including the comparators 615, 617 and the control logic 607 disables itself.

FIG. 8B depicts voltage regulation in which leakage currents draw the output voltage 207 to a voltage above the second reference voltage 619 (e.g., VDD). Times t1-t2 depict an example of a power-on phase where the regulator circuitry charges up the net output voltage 207 from ground to slightly above the first reference voltage 621 in response to detecting the rising edge of the clock signal 605 at time t1. Accordingly, at time t1, both comparators 615, 617 are activated by the first enable signal 609 and the second enable signal 611. When the first comparator 615 determines that the output voltage 207 is below the first reference voltage 621, the first comparator 615 asserts the first pulse signal 601 from times t1-t2 in order to charge the output voltage output voltage 207 up to the first reference voltage 621. From times t1-t2, the second pulse signal 603 stays deactivated because the output voltage 207 is lower than the second reference voltage 619. At time t2, when the output voltage 207 is above the first reference voltage 621, the regulator circuitry (including the control logic 607, comparators 615, 617, and output modules 205) is disabled.

Between times t2-t3 an output leakage current charges the capacitive output load of the regulator system to a positive voltage above the second reference voltage 619. Then, at time t3, the clock signal 605 activates the control logic 607 again. Both comparators 615, 617 are enabled and because the output voltage 207 is above the second reference voltage 619, the second comparator 617 asserts the second pulse signal 603 and activates the output modules 205, causing the output modules 205 to pull down the output voltage 207. The first pulse signal 601 remains deactivated at time t3 because the output voltage 207 is above the first reference voltage 621. At time t4, the output voltage 207 is corrected again to a level below the second reference voltage 619 and the regulator circuitry shuts itself down again as described above at time t2.

Between times t4-t5 the output voltage 207 gets slightly charged up again by a load current to a voltage above the second reference voltage 619. Then, at time t5, a rising edge of the clock signal 605 activates the regulator circuitry. When the regulator circuitry is activated, the second pulse 603 is asserted by the second comparator 617 from time t5-t6 until the output voltage 207 is corrected again. The regulator circuitry then shuts down at time t6 as described above with respect to time t2. Also, as described above, the first pulse signal 601 remains deactivated.

As depicted in FIG. 8B, the output voltage 207 gets regulated slightly below the second reference voltage 619 (undershoot). The undershoot is caused by the reaction time of the comparators 615, 617, control logic 607, and wire delays. Also, as described herein, the regulator activation time adapts automatically depending on the level of output voltage 207 to be corrected. Thus, as depicted in FIG. 8B, the second pulse signal 603 from times t3-t4 and times t5-t6 has different lengths. Also, as described above, the first enable signal 609 and the second enable signal 611 are asserted periodically by the control logic 607 in response to detecting a rising edge of the clock signal 605. Then, as depicted in FIG. 8B, after the power-up phase t1-t2, the first enable signal 609 is lowered after the time required for the first comparator 615 to determine the output voltage 207 has been corrected to a desired level. Similarly, when the output voltage 207 is above the second reference voltage 619, the second enable signal 611 activates the regulator circuitry as long as needed in order to correct the output voltage 207 to a level below the second reference voltage 619.

Thus, as described above, the first reference voltage 621 and second reference voltage 619 create a hysteresis window. While the output voltage 207 remains between the first reference voltage 621 and the second reference voltage 619, the regulator circuitry disables itself. Also, if the regulator circuitry is activated when the output voltage 207 is within the hysteresis window between the first reference voltage 621 and the second reference voltage 619, then both comparators 615, 617 are temporarily enabled. The comparators 615, 617 then shut down upon determining that no action is required and the control logic 607 deactivates the regulator circuitry until the next rising edge of the clock signal 605 is received.

In some cases, due to reduced switching speed of the comparators 615, 617, both comparators 615, 617 may inadvertently and simultaneously activate both the push-up and pull-down logic in the distributed output devices 205, thereby causing a cross-current to flow between the push-up and pull-down devices. In some cases, the cross-current may increase power consumption of the memory device 100 and may also damage the memory device 100. Accordingly, in one embodiment, cross current inhibit logic may be implemented to prevent cross-currents from developing.

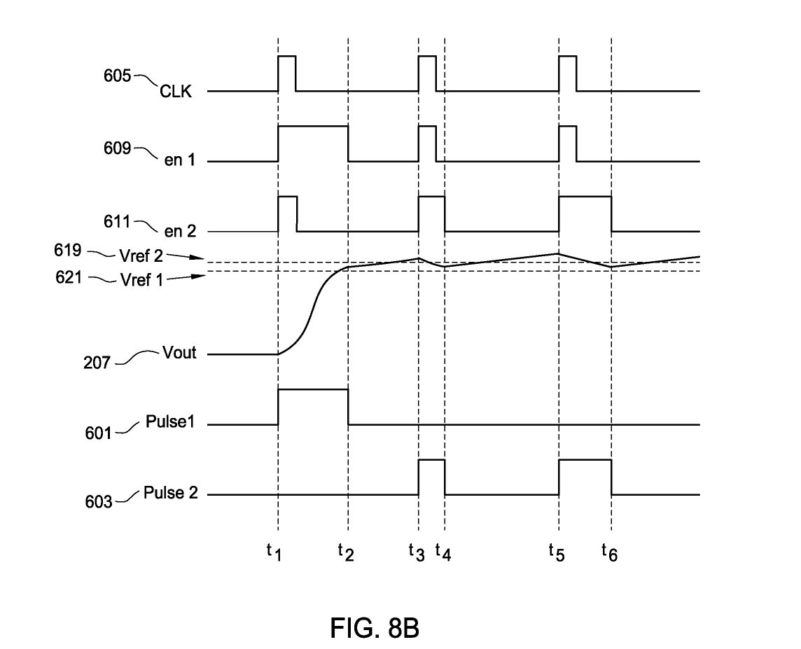

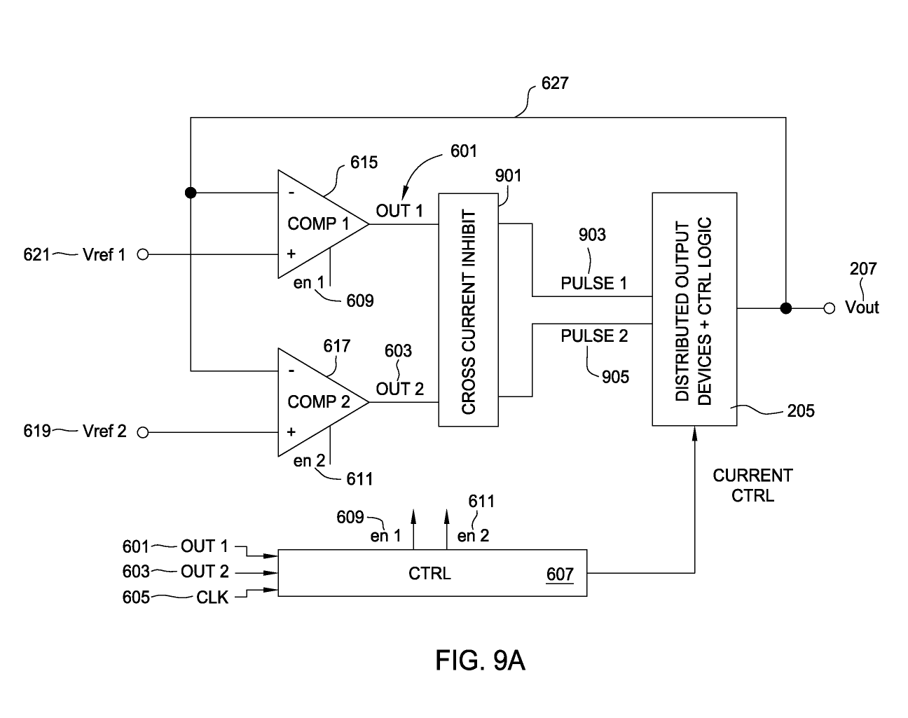

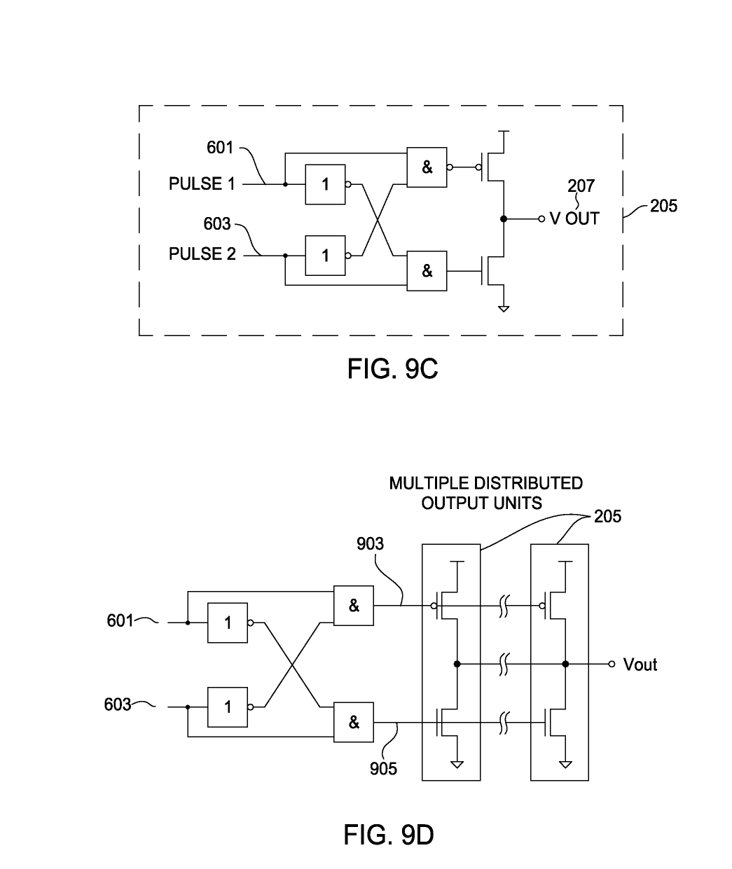

FIG. 9A shows distributed voltage regulation utilizing a clocked push-pull voltage regulator with cross-current inhibiting logic 901 according to one embodiment of the invention. The cross-current inhibit logic 901 helps maintain low power consumption by preventing a short from occurring between the supply voltage 633 and ground 639. FIG. 9B shows one implementation of such cross-current inhibiting logic 901. As depicted, the first output signal 601 and second output signal 603 are outputs from the first comparator 615 and second comparator 617, respectively. The first output signal 601 and second output signal 603 are then provided to separate inverters 907. The first output signal 601 and an inverted second output signal 911 are then fed into an AND gate 913 and output as a first pulse 903. The second output signal 603 and an inverted first output signal 909 are also fed into an AND gate 915 and outputted as a second pulse 905. AND gates 913, 915 are used to ensure that when one of the pulse signals 903, 905 is activated, the other pulse signal remains deactivated, thereby preventing cross-currents caused by simultaneous activation of the pulse signals 903, 905. In some cases, the cross-current inhibiting logic may also be distributed along with each of the distributed output units 205 as depicted in FIG. 9C. Also, as depicted in FIG. 9D, the cross-current inhibiting logic may be centrally located with the control logic 201 and provided to multiple distributed output units 205.

While described above with respect to distributing regulated voltages in a memory device, embodiments of the invention may be used with any type of integrated circuit device. While the foregoing is directed to embodiments of the present invention, other and further embodiments of the invention may be devised without departing from the basic scope thereof, and the scope thereof is determined by the claims that follow.

What is claimed is:

1. An integrated circuit device, comprising:
a plurality of pulsed digital distributed output units configured to generate one or more regulated voltages used by circuitry of the integrated circuit device; and
voltage regulator control logic configured to generate one or more control signals to control the distributed output units based, at least in part, on a comparison between one or more reference voltages and the one or more regulated voltages.

2. The integrated circuit device of claim 1, further comprising:
a plurality of memory cell arrays and access circuitry dependent on the one or more regulated voltages generated on the device.

3. The integrated circuit device of claim 1, wherein:
at least one of the distributed output units comprises a pull-up transistor coupled to a first voltage supply and a pull-down transistor coupled to a second voltage supply; and
the one or more control signals comprise at least a first pulsed signal to turn on the pull-up transistor.

4. The integrated circuit device of claim 1, further comprising:
current inhibiting logic configured to ensure the pull-up and pull-down transistors are not turned on simultaneously.

5. The integrated circuit device of claim 4, wherein the current inhibiting logic comprises:
a centrally located current inhibiting logic circuit configured to ensure the pull-up and pull-down transistors for a plurality of distributed output units are not turned on simultaneously.

6. The integrated circuit device of claim 4, wherein the current inhibiting logic comprises:
a plurality of distributed current inhibiting logic circuits, each configured to ensure the pull-up and pull-down transistors for a respective distributed output unit are not turned on simultaneously.

7. A method for regulating a voltage of an integrated circuit device, comprising:
comparing one or more reference voltages and one or more regulated voltages to determine if the one or more regulated voltages are being maintained at a desired voltage;
upon determining that the one or more regulated voltages are not being maintained at the desired voltage, generating one or more digital control signals; and
providing the one or more digital control signals to a plurality of distributed output units of the integrated circuit device, wherein each of the plurality of distributed output units, upon receiving the one or more digital control signals, is configured to generate the one or more regulated voltages.

8. The method of claim 7, wherein at least one of the distributed output units comprises a pull-up transistor coupled to a first voltage supply and wherein the one or more control signals comprise at least a first pulsed signal to turn on the pull-up transistor.

9. The method of claim 7, wherein at least one of the distributed output units comprises a pull-up transistor coupled to a first voltage supply and a pull-down transistor coupled to a second voltage supply and wherein the one or more control signals comprise at least a first pulsed signal to turn on the pull-up transistor.

10. The method of claim 7, further comprising:
preventing the pull-up and pull-down transistors from turning on simultaneously using current inhibiting logic.

11. The method of claim 10, wherein the current inhibiting logic comprises a centrally located current inhibiting logic circuit configured to ensure the pull-up and pull-down transistors for a plurality of distributed output units are not turned on simultaneously.

12. The method of claim 10, wherein the current inhibiting logic comprises a plurality of distributed current inhibiting logic circuits, each configured to ensure the pull-up and pull-down transistors for a respective distributed output unit are not turned on simultaneously.

13. An integrated circuit device comprising:
a plurality of distributed output devices, when activated, configured to generate one or more regulated voltages;
a comparator, when enabled, configured to:
determine if the one or more regulated voltages are being maintained at a desired voltage; and
upon determining that the one or more regulated voltages are not being maintained at the desired voltage, generate a digital signal configured to activate the plurality of distributed output devices; and
control circuitry configured to periodically enable the comparator.

14. The integrated circuit device of claim 13, wherein the control circuitry is configured to enable the comparator in response to receiving a clock signal.

15. The integrated circuit device of claim 14, wherein the control circuitry is configured to activate in response to receiving the clock signal.

16. The integrated circuit device of claim 15, wherein the control circuitry is configured to remain activated after receiving the clock signal for at least a defined period of time.

17. The integrated circuit device of claim 16, wherein the control circuitry is configured to remain activated after the defined period of time only if the comparator indicates that the one or more regulated voltages are not being maintained at the desired voltage.

18. The integrated circuit device of claim 17, wherein the control circuitry, upon being deactivated, is configured to disable the comparator and the plurality of distributed output devices.

19. A method for providing one or more regulated voltages, comprising:
periodically activating control circuitry for regulating the one or more regulated voltages;
upon activating the control circuitry, enabling a comparator;
upon enabling the comparator, determining whether the one or more regulated voltages are being maintained at a desired voltage; and
upon determining that the one or more regulated voltages are not being maintained at the desired voltage, generating a digital signal configured to activate a plurality of distributed output devices, wherein the plurality of distributed output devices, when activated, are configured to generate the one or more regulated voltages.

20. The method of claim 19, wherein the control circuitry is configured to enable the comparator in response to receiving a clock signal.

21. The method of claim 20, further comprising:
activating the control circuitry in response to detecting a change in the clock signal.

22. The method of claim 21, wherein the control circuitry is configured to remain activated after receiving the clock signal for at least a defined period of time.

23. The method of claim 22, wherein the control circuitry is configured to remain activated after the defined period of time only if the comparator indicates that the one or more regulated voltages are not being maintained above the first reference voltage.

24. The method of claim 23, wherein the control circuitry, upon being deactivated, is configured to disable the comparator and the plurality of distributed output devices.

25. An integrated circuit device comprising:
a plurality of distributed output devices, when activated, configured to generate one or more regulated voltages;
a first comparator, when enabled, configured to:
determine if the one or more regulated voltages are being maintained above a first reference voltage; and
upon determining that the one or more regulated voltages are not being maintained above the first reference voltage, generate a first digital signal, which, when received by the distributed output devices, causes the distributed output devices to pull up the one or more regulated voltages;
a second comparator, when enabled, configured to:
determine if the one or more regulated voltages are being maintained below a second reference voltage; and
upon determining that the one or more regulated voltages are not being maintained below the second reference voltage, generate a second digital signal, which, when received by the distributed output devices, causes the distributed output devices to pull down the one or more regulated voltages; and
control circuitry configured to periodically enable the first and second comparator.

26. The integrated circuit device of claim 25, wherein the control circuitry is configured to enable the first and second comparator in response to receiving a clock signal.

27. The integrated circuit device of claim 26, wherein the control circuitry is configured to activate in response to receiving the clock signal.

28. The integrated circuit device of claim 27, wherein the control circuitry is configured to remain activated after receiving the clock signal for at least a defined period of time.

29. The integrated circuit device of claim 28, wherein the control circuitry is configured to remain activated after the defined period of time only if the first and second comparator indicate that the one or more regulated voltages are not being maintained between the first reference voltage and the second reference voltage.

30. The integrated circuit device of claim 29, wherein the control circuitry, upon being deactivated, is configured to disable the first comparator, the second comparator, and the plurality of distributed output devices.
